(19) United States
(12) Patent Application Publication
(10) Pub. No.: US 2019/0377855 A1
(43) Pub. Date: Dec. 12, 2019

(54) BIOMETRIC DEVICE WITH LOW POWER USAGE

(71) Applicant: ZWIPE AS, Oslo (NO)

(72) Inventor: Peter Robert LOWE, Peyton, CO (US)

(73) Assignee: Zwipe AS, Oslo (NO)

(21) Appl. No.: 16/312,014

(22) PCT Filed: Jun. 30, 2017
(86) PCT No.: PCT/EP2017/066390

§ 371 Date: Dec. 20, 2018

Related U.S. Application Data
(60) Provisional application No. 62/357,445, filed on Jul. 1, 2016.

(30) Foreign Application Priority Data
Jul. 28, 2016 (GB) 1613025.4

(51) Int. Cl. G06F 21/32; G06F 1/3287; G06K 19/073

(52) U.S. Cl. CPC G06F 21/32; G06K 19/07354; G06F 1/3287

(57) ABSTRACT

A biometrically authorisable device 102 comprises: a biometric sensor 130 for obtaining biometric data from a user; a control system 114, 128 for controlling the device, wherein the control system 114, 128 is arranged to provide access to one or more protected functions of the device 102 in response to identification of an authorised user via the biometric sensor 130; and an internal power source for powering the biometric sensor 130 and the control system 114, 128; wherein the control system 114, 128 is able to place the device 102 into a zero-power standby mode when the device 102 is not in use; and wherein the device comprises a movement sensor 16 for reactivating the device 102, the movement sensor 16 generating an electrical voltage in response to movements of the device 102 and the device 102 being arranged to reactivate in response to an electrical voltage relating to one or more types of movements of the device 102.

The present invention relates to a biometrically authorisable device including features that provide for low power usage and hence longer battery life.

Biometrically authorised devices such as smartcards are becoming increasingly more widely used. Smartcards for which biometric authorisation has been proposed include, for example, access cards, credit cards, debit cards, pre-pay cards, loyalty cards, identity cards, cryptographic cards, and so on. Smartcards are electronic cards with the ability to store data and to interact with the user and/or with outside devices, for example via contactless technologies such as RFID. These cards can interact with sensors to communicate information in order to enable access, to authorise transactions and so on. Other devices are also known that make use of biometric authorisation such as fingerprint authorisation, and these include computer memory devices, building access control devices, military technologies, vehicles and so on.

The addition of a biometric sensor to the device adds a requirement for electrical energy in order to power the sensor and any associated electronics. In some cases there is a need to continually monitor for interaction of the user with the biometric sensor, and this means that there can be a continual drain on the power source of the device. It has been proposed to harvest power from external devices, such as contactless card readers and other RF emitters. However this may add complexity to the electrical circuit of the device and it means that features that require electrical power are only available whilst the device is in sufficient proximity to a suitable energy source. Therefore, many biometrically authorisable devices use an internal power source such as a battery, which allows for access to power at any time but also requires that the device has the minimum possible power usage in order to allow for the maximum lifespan before the battery needs replacing or charging.

Viewed from a first aspect the present invention provides a biometrically authorisable device comprising: a biometric sensor for obtaining biometric data from a user; a control system for controlling the device, wherein the control system is arranged to provide access to one or more protected functions of the device in response to identification of an authorised user via the biometric sensor; and an internal power source for powering the biometric sensor and the control system; wherein the control system is able to place the device into a zero-power standby mode when the device is not in use; and wherein the device comprises a movement sensor for reactivating the device, the movement sensor generating an electrical voltage in response to movements of the device and the device being arranged to reactivate in response to an electrical voltage relating to one or more types of movements of the device.

Thus, with the biometrically authorisable device of this aspect it is possible to allow for the drain on the internal power source to be stopped when the device is not in use, with the control system being reliant on an electrical voltage from the movement sensor to reactivate the device. There may be zero-power drain on the internal power source by the control system during the zero-power standby mode. That is to say, unlike some prior art devices there is no need for the control system to be continually watching for input from the user in a stand-by mode, and no need for a continuous power drain on the internal power source during stand-by. Instead, since the movement sensor generates an electrical voltage then this can be used to provide the necessary power to reactivate the device and switch the device from the zero-power standby mode to an active mode in which the internal power source is used to power the sensor and the control system.

The movements of the device used in reactivation may include an acceleration or deceleration movement, particularly a type of movement that may not regularly occur during normal handling of the device when it is not in use. In one example the movement required for reactivation is a tap of the device on a hard surface. Multiple taps may be needed. If additional security is required then the device may be arranged so that a certain sequence of taps or other movements is necessary. Provided that the electrical connections can be arranged so that the electrical voltage generated by the movement sensor during the movements can be detected and differentiated from other types of movements then there is no limitation on the particular type movement that should be used. However, given that the device also includes an added layer of security via the biometric sensor, and the device may be arranged so that upon reactivation it is still necessary to confirm the identity of the user via biometric authorisation, then a simple movement such as a tap or double tap of the device on a hard surface may be preferred.

It is required for the movement sensor generates an electrical voltage in reaction to a movement, in order that the device can move out of the zero-power standby mode without any on-going need to power a sensor. That is to say, in the zero-power standby mode there is preferably no current flowing in the device, with no active use of the internal power source. The movement sensor could be any type of sensor capable of generating an electrical voltage in reaction to a movement of the device such as an accelerating movement. A piezoelectric sensor may be used, for example a piezoelectric accelerometer, a piezoelectric sounder, or a piezoelectric microphone. Piezoelectric devices have no current draw whilst they are dormant, but produce an electrical voltage and hence can give rise to an electrical current in reaction to movement. A piezoelectric sounder is advantageous for some applications such as smartcards since the sounder can be made with a very low thickness. Suitable piezoelectric sounders may comprise a layer of piezoelectric material sandwiched between two electrodes. Sounders of this type also have microphone capabilities so that if they are tapped then they will generate a voltage between the electrodes.

The device may further include an electrical switch wherein the electrical switch can be activated by the electrical voltage generated by the movement sensor in response to the one or more types of movements of the device. The device may be arranged so that the electrical switch can be also deactivated by the electrical voltage generated by the movement sensor in response to the one or more types of movements of the device, thereby providing one possible way to place the device into the zero-power standby mode. Alternatively or additionally the control system, when active, may be able to control the electrical switch and in particular may be able to change the state of the electrical switch to place the device into the zero-power standby mode. The electrical switch may for example be part of a connection of the internal power source to the control system and/or the biometric sensor. It is preferred for the electrical switch to be a low powered device, and electrical switch may for example be a transistor such as a field effect transistor (FET), for example a CMOS FET.

The device may be arranged so that an electrical voltage higher than a threshold level is required in order to reactivate the device. The threshold level may be set using an electrical circuit connecting the movement sensor to the electrical switch. Alternatively or additionally the electrical switch may be selected in accordance with a desired threshold voltage for switching.

In the case where multiple movements are needed in order to reactivate the device then a first movement, for example a first tap, may cause the electrical switch to switch between states and connect the internal power source to the control system, after which the control system may monitor for the next required movement, such as a second tap or some other more complicated movement. Alternatively, one implementation using a double tap may use two electrical switches electrically connected together so that both switches need to be activated in order to reconnect the internal power source to the control system, and so that the second switch can be activated only after the first switch is activated. Thus, a first tap may activate the first electrical switch and the second tap may then activate the second electrical switch, with full reactivation of the device being completed when both electrical switches have changed state and the internal power source is reconnected to the control system.

The zero-power standby mode may require an additional authorisation after reactivation of the control system before full use of the device is permitted, such as a specific sequence of movements to be detected and/or authorisation with the biometric sensor.

The device may be arranged enter a dormant mode and require reactivation or re-authorisation for continued use after it has been left unused for a period of time, for example for several minutes or several hours depending on the intended use of the device. The dormant mode may be the zero-power standby mode, hence requiring reactivation via the movements discussed above. In this case the control system may be arranged to switch the electrical switch and disconnect the battery in order to put the device into the dormant mode.

The device may be arranged to enter a dormant mode in response to interaction with the user, for example in response to movement detected by the movement sensor. This may be the dormant mode as above and hence may be the zero-power standby mode. When this feature is combined with the requirement for biometric authorisation after the device is reactivated from being in the zero-power standby mode then there is yet further security, since the user can purposefully deactivate the smartcard, for example by tapping movement or other movement, when they wish to ensure that the biometric security is active. The movement that causes deactivation may be the same as or different to the movement that causes reactivation, and it may be any movement as discussed above. In one example it is a tapping movement. In a further refinement of this the control system may be arranged to associate certain movements with loss or theft of the device and to then put the device into the dormant mode when such movements are detected. For example, if a device is snatched from the user's hand then this will have a characteristic pattern of movement and acceleration, which can be sensed by the movement sensor and matched by the control system to a preset sequence of movements that is deemed to require the device to be placed into the dormant mode.

With some types of movement sensors it may be possible to detect movements characteristic of dropping of the device, such as freefall followed by an impact. This may be another preset sequence of movements that is deemed to require the device to be placed into the dormant mode in order that if the device is inadvertently dropped then it cannot be picked up by an unauthorised user when still in an active state.

In a variation of the above deactivation feature then the control system may be arranged so that rather than fully deactivating the device by moving to the dormant or zero-power standby mode, the control system simply cancels any existing biometric authorisation in order that subsequent use of the device will require renewed biometric authorisation.

The feature of switching to a dormant mode (which may be the zero-power standby mode) in the event of movements associated with a potential theft or loss of the device, with reactivation of the device then requiring re-identification of the user via the biometric sensor, is considered novel and inventive in its own right. Thus, a separate aspect of the invention, which is not currently independently claimed, provides a biometrically authorisable device comprising: a biometric sensor for obtaining biometric data from a user; a control system for controlling the device, wherein the control system is arranged to provide access to one or more protected functions of the device in response to identification of an authorised user via the biometric sensor; and a movement sensor; wherein the device arranged to go into a dormant mode in response to certain movements of the device detected by the movement sensor, wherein the certain movements are types or combinations of movements associated with a potential theft or loss of the device.

The device of the above separate aspect may be combined with any or all features discussed above, with or without the features of the first aspect relating to the use of an internal power source, a movement sensor generating an electrical voltage and the zero-power standby mode. The features discussed below are in relation to the first aspect or to this separate aspect.

The internal power source may be battery of any suitable type, for example a lithium ion battery or capacitive type energy storage devices.

Although movements can be detected by a movement sensor with a single sensing axis, it is preferred to be able to detect movements such as accelerations in all directions. This may be done via multiple movement sensors, but preferably a single sensor is used that can detect acceleration in all directions, such as a tri-axis accelerometer or a piezoelectric sounder.

The movement sensor can optionally also interact with the control system when the device is activated, for example to change the operating mode of the device in response to pre-set movements. Thus, the movement sensor may be utilised for more than just activation of the device and this can increase the functionality of the device without adding further hardware components. This can be an important advantage where there is a need for tight control on the size of the device, such as for a portable device like a smartcard.

Thus, the control system, when not in the zero-power standby mode, may be arranged to identify movements of the device based on the output of the movement sensor. The movements of the device sensed by the movement sensor may include any movement or combinations of movements that will produce an electrical voltage at the movement sensor. Depending on the sensor type this may include some or all of rotation of the device in one or more directions (clockwise/anticlockwise) and/or in one or more than one axis of rotation, translation of the device in one or more directions (forward/backward) and along one or more axis, and/or accelerations in one or more directions (forward/backward) and along one or more axis as well as jerk or impulses in one or more directions (forward/backward) and along one or more axis. Combinations of these movements may also be detected, for example a “flick” motion including a combination of translation and acceleration/deceleration to characterise the movement detected by the sensor.

Rotations of the device may include changes in orientation of the device, for example switching a smartcard from portrait to landscape orientation or turning the card over. The rotations may include 90 degree turns, 180 degree turns, 270 degree turns or 360 degree turns, or intervening values, in any direction.

Translational movements may include waving motions, optionally in combination with acceleration/deceleration as with a flicking type motion, or a tapping motion.

As noted above, the control system may be arranged to identify the movements of the device based on the electrical voltage output by the movement sensor, and use this to change the operating mode of the device in response to pre-set movements. The pre-set movements may include any or all movements discussed above. In addition, the control system may determine the length of a time period without motion, i.e. a time period indicative of no active usage of the device, and this may also be used to change the operating mode of the device, for example to put the device into the zero-power standby mode. The control system may also be arranged to identify repeated movements or sequences of movements, such as a double tap, or a translational movement followed by a rotation such as a sliding and twisting motion. Advantageously, the device may be arranged to allow the user to set their own movements and or combinations of movements. For example the control system may have a learn mode where a combination of movements by the user can be taught to the control system and then allocated to a specific change in the operating mode of the device. This can provide for increased security by the use of movements that may be unique to each individual.

The operating modes of the device that are controlled based on the output voltage of the movement sensor may be related to a high level function, for example turning the device on or off, activating secure aspects of the device such as contactless payment, or changing the basic functionality of the device for example by switching a smartcard between operating as an access card, a payment card, or a transportation smartcard, switching between different accounts of the same type (e.g. two bank accounts) and so on.

Alternatively or additionally the operating modes of the device that are controlled based on the output voltage of the movement sensor may concern more specific functionalities of the device, for example switching between communications protocols (such as blue tooth, wifi, NFC) and/or activating a communication protocol, activating a display such as an LCD or LED display or obtaining an output from the device, such as a one-time-password or the like.

Alternatively or additionally the operating modes of the device that are controlled based on the output voltage of the movement sensor may include prompting the device to automatically perform a standard operation of the device. Examples of such standard operations might include a smartcard carrying out a pre-set cash withdrawal in response to a specific movement during or prior to communication with an ATM, entering into a learning or set-up mode, PIN activation of a smartcard (i.e. movements used in place of a PIN entry via a keypad on an external card reader), sending a message to a contactless reader or a smartphone (e.g. via NFC) and so on.

The control system may be arranged to allow for the user to specify the movements (including combinations of different interactions or movements) that should activate particular operating modes. The control system may use different movements for each one of a set of operating modes, or alternatively it may cycle through the operating modes of a set of operating modes in response to a repeated movement.

Examples of combinations of movements and changes in the operating mode of the device include: flicking a smartcard to switch the card application between, for example, access card, payment card, transport system card, turning on the device via a pre-set (preferably user specified) activation gesture, turning the device 180 degrees to switch between blue tooth and NFC, double tap on a surface to activate a display and so on. These movements should of course be set based on the sensing capabilities of the movement sensor.

The control system may be arranged to use a pre-set combination of movements as an alternative authorisation in the case that the biometric sensor fails. In this situation the control system may permit the user full access or only partial access to the features of the device that are protected by the biometric authorisation process. This can be useful in situations where the user might be unable to use the biometric sensor, for example in the case of a fingerprint sensor where the user has damaged their finger.

The biometric sensor may be a fingerprint sensor and thus the biometric data may be fingerprint data.

The authorised user may initially enrol their biometric data with the device, optionally indirectly through some other device, or alternatively directly onto the device via the biometric sensor, and may then typically be required to provide biometric data via the biometric sensor in order to authorise some or all uses of the device. A biometric matching algorithm in the control system may be used to identify a biometric match between an enrolled user and a biometric data sensed by the biometric sensor. This may be based on biometric data stored on the device or on biometric data stored in some remote location and accessible to the device via a communication system. In the event of a failure to match the biometric data, the control system may prevent access to the one or more protected functions of the device and/or may issue a prompt for an alternative form of authorisation, for example via movements of the device.

It is preferred for the device to be arranged so that it is impossible to extract the data used for identifying users via biometric authorisation. The transmission of this type of data outside of the device is considered to be a risk to the security of the device.

To avoid any need for communication of the biometric data outside of the device then the device may be able to self-enrol, i.e. the control system may be arranged to enrol an authorised user by obtaining biometric data via the biometric sensor. This also has advantages arising from the fact that the same sensor with the same geometry is used for the enrolment as for the biometric authorisation. The biometric data can be obtained more consistently in this way compared to the case where a different sensor on a different device is used for enrolment. With biometrics, one problem has been that it is difficult to obtain repeatable results when the initial enrolment takes place in one place, such as a dedicated enrolment terminal, and the subsequent enrolment for matching takes place in another, such as the terminal where the matching is required. This is a known issue for fingerprint sensors for example. The mechanical features of the housing around each fingerprint sensor must be carefully designed to guide the finger in a consistent manner each time it is read by any one of multiple sensors. If a fingerprint is scanned with a number of different terminals, each one being slightly different, then errors can occur in the reading of the fingerprint. Conversely, if the same fingerprint sensor is used every time then the likelihood of such errors occurring is reduced.

In accordance with the proposed device, both the matching and enrolment scans may be performed using the same biometric sensor. As a result, scanning errors can be balanced out because, for example, if a user tends to present their finger with a lateral bias during enrolment, then they are likely to do so also during matching.

The control system may have an enrolment mode in which a user may enrol their biometric data via the biometric sensor, with the biometric data generated during enrolment being stored on the memory. The control system may be arranged to prompt the user for enrolment of a movement sequence to act as an alternative mode of authorisation in addition to biometric enrolment (i.e. to allow for later failures in biometric authorisation) and/or in the event of a failure to enrol the user via the biometric sensor.

The control system may be in the enrolment mode when the device is first provided to the user, so that the user can immediately enrol their biometric data. The first enrolled user may be provided with the ability to later prompt an enrolment mode for subsequent users to be added, for example via input on an input device of the device after identification has been confirmed. Alternatively or additionally it may be possible to prompt the enrolment mode of the control system via outside means, such as via interaction between the device and a secure system, which may be a secure system controlled by the manufacturer or by another authorised entity.

The device may be a portable device, by which is meant a device designed for being carried by a person, preferably a device small and light enough to be carried conveniently. The device can be arranged to be carried within a pocket, handbag or purse, for example. The device may be a smartcard such as a biometric authorisable RFID card. The device may be a control token for controlling access to a system external to the control token, such as a one-time-password device for access to a computer system or a fob for a vehicle keyless entry system. The device is preferably also portable in the sense that it does not rely on a wired power source. The device may be powered by an internal battery and/or by power harvested contactlessly from a reader or the like, for example from an RFID reader.

The device may be a single-purpose device, i.e. a device for interacting with a single external system or network or for interacting with a single type of external system or network, wherein the device does not have any other purpose. Thus, the device is to be distinguished from complex and multi-function devices such as smartphones and the like.

The protected functions of the device are features where the user or the issuer of the device requires the use of added security to check the identity of the user before access is permitted. These may be protected features of the type where in the prior art a PIN or single use code is needed to access them. The protected features will vary depending on the intended use for the device, and might include access to carry out financial transactions via a smartcard, access to areas of a building, access to a vehicle or the like using the device as a keyless entry token, and so on.

Where the device is a smartcard then the smartcard may be any one of: an access card, a credit card, a debit card, a pre-pay card, a loyalty card, an identity card, a cryptographic card, or the like. The smartcard preferably has a width of between 85.47 mm and 85.72 mm, and a height of between 53.92 mm and 54.03 mm. The smartcard may have a thickness less than 0.84 mm, and preferably of about 0.76 mm (e.g. ±0.08 mm). More generally, the smartcard may comply with ISO 7816, which is the specification for a smartcard.

Where the device is a control token it may for example be a keyless entry key for a vehicle, in which case the external system may be the locking/access system of the vehicle and/or the ignition system. The external system may more broadly be a control system of the vehicle. The control token may act as a master key or smart key, with the radio frequency signal giving access to the vehicle features only being transmitted in response to biometric identification of an authorised user. Alternatively the control token may act as a remote locking type key, with the signal for unlocking the vehicle only being able to be sent if the biometric authorisation module identifies an authorised user. In this case the identification of the authorised user may have the same effect as pressing the unlock button on prior art keyless entry type devices, and the signal for unlocking the vehicle may be sent automatically upon biometric identification of an authorised user, or sent in response to a button press when the control token has been activated by authentication of an authorised user.

The device may be capable of wireless communication, such as using RFID or NFC communication. Alternatively or additionally the device may comprise a contact connection, for example via a contact pad or the like such as those used for “chip and pin” payment cards. In various embodiments, the device may permit both wireless communication and contact communication.

Viewed from a second aspect, the invention provides a method for controlling a biometrically authorisable device comprising: a biometric sensor for obtaining biometric data from a user; a control system for controlling the device; an internal power source for powering the biometric sensor and the control system; and a movement sensor that generates an electrical voltage in response to movements of the device; the method comprising: providing access to one or more protected functions of the device in response to identification of an authorised user via the biometric sensor; placing the device in a zero-power standby mode when the device is not in use; and using an electrical voltage from the movement sensor relating to one or more types of movements of the device to trigger reactivation of the device and take it out of the zero-power standby mode.

The device in this method may include features as described above in connection with the first aspect, and the method may include controlling the device as set out above. The method may hence include reactivating the device in response to a movement as discussed above, such as a tap of the device on a hard surface. The method may include deactivating the device in response to a pre-set movement associated with a theft or loss of the card and/or when the device has undergone a period of inactivity. The method may comprise using an electrical switch such as a transistor as set out above. After reactivation the method may include requiring renewed identification of the authorised used via the biometric sensor.

The invention further extends, in an aspect that is not currently independently claimed, to a method for controlling a biometrically authorisable device comprising: a biometric sensor for obtaining biometric data from a user; a control system for controlling the device; and a movement sensor; the method comprising: providing access to one or more protected functions of the device in response to identification of an authorised user via the biometric sensor; placing the device in a dormant mode in response to certain movements of the device detected by the movement sensor, wherein the certain movements are types or combinations of movements associated with a potential theft or loss of the device; and requiring re-identification of the authorised user via the biometric sensor after the device has been put into the dormant mode and before subsequent use of the one or more protected functions of the device. This method may also include features discussed above in connection with the method of the second aspect, and may include use of the features discussed above in relation to the biometric device.

Certain preferred embodiments on the present invention will now be described in greater detail, by way of example only and with reference to the accompanying drawings, in which:

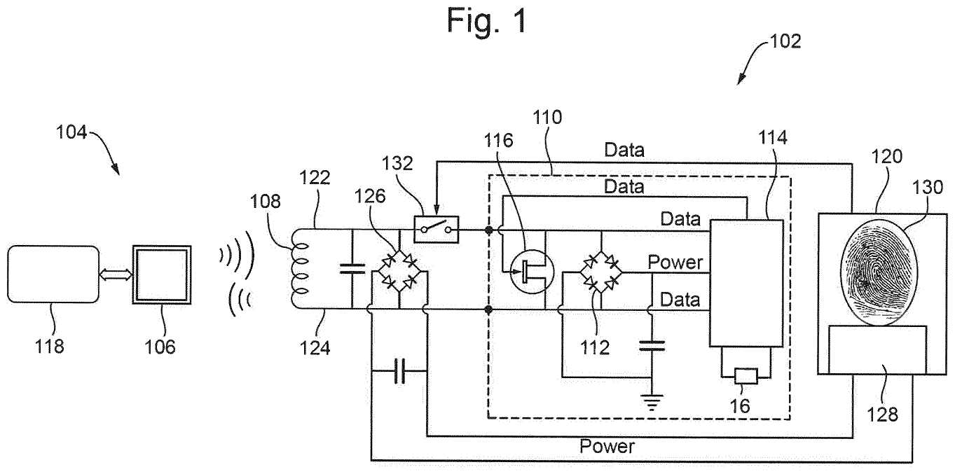

FIG. 1 illustrates a circuit for a smartcard with a fingerprint sensor;

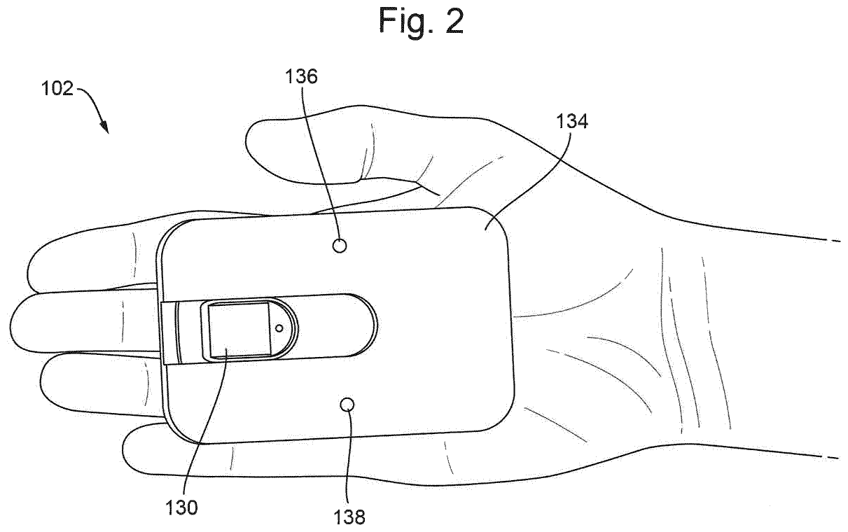

FIG. 2 illustrates a smartcard including an external housing; and

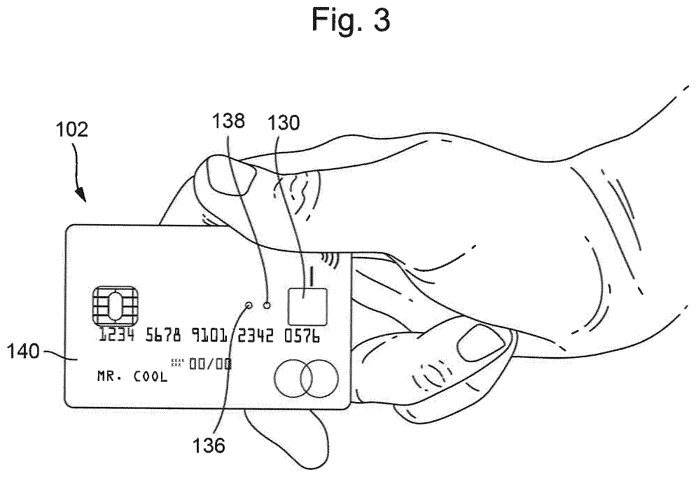

FIG. 3 illustrates a smartcard with a laminated card body.

By way of example the invention is described in the context of a fingerprint authorised smartcard that includes contactless technology and uses power harvested from the card reader as well as having a battery. These features are envisaged to be advantageous features of one application of a biometric device with a movement sensor, but are not seen as essential features. A smartcard may hence alternatively use a physical contact and/or be powered only by the battery, for example.

FIG. 1 shows the architecture of a smartcard 102 that is provided with the proposed movement sensor and zero-power off functionality. A powered card reader 104 transmits a signal via an antenna 106. The signal is typically 13.56 MHz for MIFARE® and DESFire® systems, manufactured by NXP Semiconductors, but may be 125 kHz for lower frequency PROX® products, manufactured by HID Global Corp. This signal is received by an antenna 108 of the smartcard 102, comprising a tuned coil and capacitor, and then passed to a communication chip 110. The received signal is rectified by a bridge rectifier 112, and the DC output of the rectifier 112 is provided to processor 114 that controls the messaging from the communication chip 110.

A control signal output from the processor 114 controls a field effect transistor 116 that is connected across the antenna 108. By switching on and off the transistor 116, a signal can be transmitted by the smartcard 102 and decoded by suitable control circuits 118 in the sensor 104. This type of signalling is known as backscatter modulation and is characterised by the fact that the sensor 104 is used to power the return message to itself.

A movement sensor 16 is connected in an appropriate way to the processor 114, and the connection includes an electrical switch such as a transistor that is also linked with the battery (not shown) of the device. The movement sensor 16 generates an electrical voltage in response to some or all movements of the smartcard 102. This sensor 16 might be a piezoelectric sounder or a MEMs piezoelectric accelerometer, for example.

In order to avoid a drain on the battery when the smartcard 102 is not in use there is a zero-power standby feature. An electrical switch such as a transistor links the battery to the processor 114 and other elements of the electrical circuit of the smartcard 102. The processor 114 can disconnect the battery using the electrical switch when it is required to place the smartcard 102 into a zero-power standby mode. For example, this may be when the smartcard 102 has been inactive beyond a certain length of time, or when the user interacts with the smartcard 102 in a way that has been set up to prompt the zero-power standby mode. In one example a tap of the smartcard 102 on a hard surface with sufficient force will cause the processor 114 to switch from an active mode into a zero-power standby mode.

With the use of such a zero-power standby feature then there is no use of the battery when the card is not in use. This is to be contrasted with smartcards where the processor 114 is always “watching” for the user to use the fingerprint sensor 130 or otherwise interact with the card.

In order for a zero-power standby feature to be practical it is necessary to also have a convenient means for turning the card back on, and the proposed smartcard 102 uses the movement sensor 16 for this purpose. Since the movement sensor 16 generates an electrical voltage in response to a movement that it does not need the battery to be connected for it to be able to reactivate the processor 114. Instead, the electrical voltage can be used to activate the electrical switch that connects the battery with the processor 114 and other elements of the electrical circuit of the smartcard 102. In particular, the electrical switch can be a transistor which is switched from one state to another in reaction to the electrical voltage generated by the movement sensor 16. The threshold voltage that is required to activate the transistor can be set such that the smartcard 102 only moves out of the standby mode when there is a sufficiently positive movement, for example a tap of the smartcard 102 on a hard surface. The voltage should be calibrated in order to avoid an excessive frequency of inadvertent activation of the smartcard 102 whilst it is being carried by the user.

In order to add extra security then when the smartcard 102 moves from the zero-power standby mode to the active mode it also requires biometric authorisation, via the fingerprint sensor 130 in this case, before full access to protected functions of the smartcard 102 is permitted. As noted above when the smartcard 102 is active then it could be arranged so that a tap of the smartcard 102 on a hard surface will cause the processor 114 to switch from an active mode into the zero-power standby mode. When this feature is combined with the requirement for biometric authorisation after the card is reactivated from being in the zero-power standby mode then there is yet further security, since the user can quickly tap the card when they wish to ensure that the biometric security is active. In many situations it is possible to tap the card when a user feels that there is a risk of theft or for any reason becomes uncomfortable with the situation in relation to access to the secure features on the smartcard 102. In a further refinement of this the processor 114 can be arranged to associate certain movements with loss or theft of the smartcard 102 and to then deactivate the card by disconnecting the battery when such movements are detected.

For example, if a smartcard 102 is snatched from the user's hand then this will have a characteristic pattern of movement and acceleration of the card 102, which can be sensed by the movement sensor 16 and matched by the processor 114 to a preset sequence of movements that is deemed to require deactivation of the smartcard 102. In addition, with some types of movement sensors 16 it may be possible to detect movements characteristic of dropping of the smartcard 102, such as freefall followed by an impact. This could be another preset sequence of movements that is deemed to require deactivation of the smartcard 102 in order that if the card is inadvertently dropped then it cannot be picked up by an unauthorised user still in an active state.

Similar advantages in relation to theft or loss of the card can be obtained in a variation of the above feature in which rather than fully deactivating the card by disconnection of the battery at the electronic switch, the processor 114 simply cancels any existing biometric authorisation so that subsequent use of the card will require renewed biometric authorisation.

The movement sensor 16 might also be used to control operation of the smartcard 102 whilst the card is activated, in which case it senses movements of the card and provides an output signal to the processor 114, which is arranged to detect and identify movements that are associated with required operating modes on the card as discussed below.

The smartcard further includes a fingerprint authentication engine 120 including a fingerprint processor 128 and a fingerprint sensor 130. This allows for enrolment and authorisation via fingerprint identification. The fingerprint processor 128 and the processor 114 that controls the communication chip 110 together form a control system for the device. The two processors could in fact be implemented as software modules on the same hardware, although separate hardware could also be used.

The antenna 108 comprises a tuned circuit including an induction coil and a capacitor, which are tuned to receive an RF signal from the card reader 104. When exposed to the excitation field generated by the sensor 104, a voltage is induced across the antenna 108.

The antenna 108 has first and second end output lines 122, 124, one at each end of the antenna 108. The output lines of the antenna 108 are connected to the fingerprint authentication engine 120 to provide power to the fingerprint authentication engine 120. In this arrangement, a rectifier 126 is provided to rectify the AC voltage received by the antenna 108. The rectified DC voltage is smoothed using a smoothing capacitor and then supplied to the fingerprint authentication engine 120. In addition to the use of harvested power the smartcard also has a battery (not shown) that supplies power when harvested power is not available and also optionally can be used in parallel with the harvested power. In some cases the harvested power may be used to re-charge the battery and to thereby indirectly power other parts of the smartcard, rather than being used to power the sensor 16 and fingerprint authentication engine 120 directly.

The fingerprint sensor 130 of the fingerprint authorisation engine, which can be an area fingerprint sensor 130, may be mounted on a card housing 134 as shown in FIG. 2 or fitted so as to be exposed from a laminated card body 140 as shown in FIG. 3. The card housing 134 or the laminated body 140 encases all of the components of FIG. 1, and is sized similarly to conventional smartcards. The processor 128 comprises a microprocessor that is chosen to be of very low power and very high speed, so as to be able to perform fingerprint matching in a reasonable time.

The fingerprint authentication engine 120 is arranged to scan a finger or thumb presented to the fingerprint sensor 130 and to compare the scanned fingerprint of the finger or thumb to pre-stored fingerprint data using the processor 128. A determination is then made as to whether the scanned fingerprint matches the pre-stored fingerprint data. In a preferred embodiment, the time required for capturing a fingerprint image and authenticating the bearer of the card 102 is less than one second.

If a fingerprint match is determined and/or if appropriate movements are detected via the movement sensor 16, then the processor takes appropriate action depending on its programming. In this example the fingerprint authorisation process is used to authorise the use of the smartcard 104 with the contactless card reader 104. Thus, the communication chip 110 is authorised to transmit a signal to the card reader 104 when a fingerprint match is made. The communication chip 110 transmits the signal by backscatter modulation, in the same manner as the conventional communication chip 110. The card may provide an indication of successful authorisation using a suitable indicator, such as a first LED 136.

The fingerprint processor 128 and the processor 114 can receive an indication of a non-fingerprint interaction with the fingerprint sensor 130, which can include any action detectable via the fingerprint sensor 130 as discussed above. The interaction of the user with the card via the fingerprint sensor 130 are used as a part of a non-fingerprint authorisation and also may be used to allow the user to control the smartcard by switching between different operating modes of the smartcard.

In some circumstances, the owner of the fingerprint smartcard 102 may suffer an injury resulting in damage to the finger that has been enrolled on the card 102. This damage might, for example, be a scar on the part of the finger that is being evaluated. Such damage can mean that the owner will not be authorised by the card 102 since a fingerprint match is not made. In this event the processor 114 may prompt the user for a back-up identification/authorisation check via an alternative interaction with the smartcard 102, which in this case includes one or more action(s) detected via the fingerprint sensor 130 and also optionally actions detected via other sensors, such as the movement sensor 16. The card may prompt the user to use a back-up identification/authorisation using a suitable indicator, such as a second LED 138. It is preferred for the non-fingerprint authorisation to require a sequence of interactions with the card by the user, this sequence being pre-set by the user. The pre-set sequence for non-fingerprint authorisation may be set when the user enrols with the card 102. The user can hence have a non-fingerprint authorisation in the form of a “password” entered using non-fingerprint interactions with the card to be used in the event that the fingerprint authorisation fails. The same type of non-fingerprint authorisation can be used in the event that a user is unable or unwilling to enrol with the card 102 via the fingerprint sensor 130.

Thus, as well as allowing communication via the circuit 110 with the card reader 104 in response to a fingerprint authorisation via the fingerprint sensor 130 and fingerprint processor 128 the processor 114 may also be arranged to allow such communication in response to a non-fingerprint authorisation.

When a non-fingerprint authorisation is used the card 102 could be arranged to be used as normal, or it could be provided with a degraded mode in which fewer operating modes or fewer features of the card 102 are enabled. For example, if the smartcard 102 can act as a bank card then the non-fingerprint authorisation might allow for transactions with a maximum spending limit lower than the usual maximum limit for the card 102.

The processor 114 receives the output from the movement sensor 16 and this allows the processor 114 to determine what movements of the smart card 102 have been made. The processor 114 identifies pre-set movements and other actions of the user that are linked with required changes to the operating mode of the smartcard. As discussed above, the movements may include any type of or combination of rotation, translation, acceleration, impulse and other movements detectable by the movement sensor 16. The other actions of the user may include actions detected via the fingerprint sensor, such as taps, swipes and so on as discussed above.

The operating modes that the processor 114 activates or switches to in response to an identified movement associated with the required change in operating mode may include any mode of operation as discussed above, including turning the card on or off, activating secure aspects of the card 102 such as contactless payment, or changing the basic functionality of the card 102 for example by switching between operating as an access card, a payment card, a transportation smartcard, switching between different accounts of the same type (e.g. two bank accounts), switching between communications protocols (such as blue tooth, wifi, NFC) and/or activating a communication protocol, activating a display such as an LCD or LED display, obtaining an output from the smartcard 102, such as a one-time-password or the like, or prompting the card 102 to automatically perform a standard operation of the smartcard 102.

The processor 114 has an enrolment mode, which may be activated upon first use of the smartcard 102. In the enrolment mode the user is prompted to enrol their fingerprint data via the fingerprint sensor 130. This can require a repeated scan of the fingerprint via the fingerprint sensor 130 so that the fingerprint processor 128 can build up appropriate fingerprint data, such as a fingerprint template. After a successful or an unsuccessful enrolment of fingerprint data the user may be prompted to enter a non-fingerprint authorisation. This could be optional in the case of a successful fingerprint enrolment, or compulsory if the fingerprint enrolment was not successful. The non-fingerprint authorisation might include movements detected by the movement sensor 16. The processor 114 can keep a record of these interactions in a memory, and it is arranged to provide at least partial authorisation to use some of the functions of the card in the event that the non-fingerprint authorisation is provided by the user.

The processor 114 can have a learn mode to allow for the user to specify which actions (including combinations of actions/interactions) should activate particular operating modes whilst the smartcard 102 is in use. This type of control of the smartcard 102 might be enabled only after a successful fingerprint or non-fingerprint authorisation. In the learn mode the processor 114 prompts the user to make the desired sequence of actions, and to repeat the movements for a predetermined set of times. These movements are then allocated to the required operating mode or to the non-fingerprint authorisation. With this latter feature the learn mode can allow for the sequence of movements used for the non-fingerprint authorisation to be changed by the user in the same way that a traditional PIN can be changed.

1. A biometrically authorisable device comprising:
a biometric sensor for obtaining biometric data from a user;
a control system for controlling the device, wherein the control system is arranged to provide access to one or more protected functions of the device in response to identification of an authorised user via the biometric sensor; and
an internal power source for powering the biometric sensor and the control system;
wherein the control system is able to place the device into a zero-power standby mode when the device is not in use; and
wherein the device comprises a movement sensor for reactivating the device, the movement sensor generating an electrical voltage in response to movements of the device and the device being arranged to reactivate in response to an electrical voltage relating to one or more types of movements of the device.

2. A biometrically authorisable device as claimed in claim 1, wherein the one or more types of movements of the device that trigger reactivation include an acceleration or a deceleration movement that does not regularly occur during normal handling of the device whilst it is not in use.

3. A biometrically authorisable device as claimed in claim 1 or 2, wherein the one or more types of movements of the device that trigger reactivation include a tap of the device on a hard surface.

4. A biometrically authorisable device as claimed in claim 1, 2 or 3, wherein the one or more types of movements of the device that trigger reactivation include a repeated tap of the device on a hard surface.

5. A biometrically authorisable device as claimed in any preceding claim, wherein since the movement sensor generates an electrical voltage in reaction to a movement then the device is arranged to move out of the zero-power standby mode and be reactivated without any on-going supply of power from the internal power source to the control system in the zero-power standby mode.

6. A biometrically authorisable device as claimed in any preceding claim, wherein the movement sensor is a piezoelectric sensor such as a piezoelectric accelerometer, a piezoelectric sounder, or a piezoelectric microphone.

7. A biometrically authorisable device as claimed in claim 6, wherein the piezoelectric sensor is a piezoelectric sounder comprising a layer of piezoelectric material sandwiched between two electrodes.

8. A biometrically authorisable device as claimed in any preceding claim, comprising: an electrical switch forming part of a connection of the internal power source to the control system and/or the biometric sensor; wherein a change in state of the electrical switch reactivates the device; and wherein the electrical switch is activated by the electrical voltage generated by the movement sensor in response to the one or more types of movements of the device.

9. A biometrically authorisable device as claimed in claim 8, wherein the device is arranged so that an electrical voltage higher than a threshold level is required in order to trigger the electrical switch.

10. A biometrically authorisable device as claimed in any preceding claim, wherein the control system is arranged such that after reactivation of the device from the zero-power standby mode an additional authorisation is required before full use of the device is permitted.

11. A biometrically authorisable device as claimed in any preceding claim, wherein the device is arranged enter the zero-power standby mode after it has been left unused for a period of time.

12. A biometrically authorisable device as claimed in any preceding claim, wherein the device is arranged to enter the zero-power standby mode in response to interaction with the user.

13. A biometrically authorisable device as claimed in claim 12, wherein the interaction with the user is a movement detected via the movement sensor

14. A biometrically authorisable device as claimed in any preceding claim, wherein the device is arranged enter the zero-power standby mode in response to the movement sensor detecting certain movements that are associated with loss or theft of the device.

15. A biometrically authorisable device as claimed in any preceding claim, wherein the control system is arranged to identify movements of the device based on the electrical voltage output by the movement sensor when the device is activated, and to change the operating mode of the device in response to pre-set movements.

16. A biometrically authorisable device as claimed in any preceding claim, wherein the biometric sensor is a fingerprint sensor.

17. A biometrically authorisable device as claimed in any preceding claim, wherein the device is a smartcard.

18. A method for controlling a biometrically authorisable device comprising: a biometric sensor for obtaining biometric data from a user; a control system for controlling the device; an internal power source for powering the biometric sensor and the control system; and a movement sensor that generates an electrical voltage in response to movements of the device; the method comprising:
providing access to one or more protected functions of the device in response to identification of an authorised user via the biometric sensor;
placing the device in a zero-power standby mode when the device is not in use; and
using an electrical voltage from the movement sensor relating to one or more types of movements of the device to trigger reactivation of the device and take it out of the zero-power standby mode.

19. A method as claimed in claim 18, comprising reactivating the device in response to an acceleration or a deceleration movement that does not regularly occur during normal handling of the device whilst it is not in use.

20. A method as claimed in claim 18 or 19, comprising placing the device in the zero-power mode in response to a pre-set movement associated with a theft or loss of the card and/or when the device has undergone a period of inactivity.

21. A method as claimed in claim 18, 19 or 20, comprising requiring renewed identification of the authorised used via the biometric sensor after the device is reactivated and taken out of the zero-power standby mode.
